(19) United States
(12) Patent Application Publication
(10) Pub. No.: US 2007/0153747 A1
(43) Pub. Date: Jul. 5, 2007

(54) Method and apparatus for soft switching

(76) Inventors: Sheng Pan, Shanghai (CN); Li Sun, Shanghai (CN); Ni Ma, Shanghai (CN); Jiang Cheng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/557,626

(22) PCT Filed: May 6, 2004
(86) PCT No.: PCT/IB04/50605

§ 371 Date: Dec. 5, 2006

(30) Foreign Application Priority Data
May 19, 2003 (CN) 03123742.8

(51) Int. Cl. H04Q 7/24

(52) U.S. Cl. 370/338

(57) ABSTRACT

A method in wireless communication systems is provided for switching from P2P (Peer to Peer) communication mode to UP-UTRAN-DOWN (conventional communication mode) and from conventional communication mode to P2P mode, wherein the method performed by a user equipment for switching from P2P communication mode to conventional communication mode comprising steps of: detecting the direct link used by the user equipment in P2P communication with the other user equipment; sending a request for switching to conventional communication mode to a wireless communication network system if the detecting result indicates that the communication quality of the direct link can't satisfy the requirement for P2P communication; and establishing conventional communication connection so as to communicate with said the other user equipment in conventional mode, after receiving the acknowledge (ACK) message of the request for switching sent by the network system.

### FIELD OF THE INVENTION

The present invention relates to a method and apparatus capable of introducing P2P (Peer to Peer) communication in wireless communication systems, and more particularly, to a method and apparatus for soft switching between P2P communication mode and conventional communication mode in wireless communication systems.

### BACKGROUND ART OF THE INVENTION

In conventional cellular communication systems, a UE (user equipment) has to communicate with another UE only through the relaying of base stations regardless of the distance between the two UEs. FIG. 1 illustrates such conventional communication mode, wherein UE1 and UE2 interact with each other through the UTRAN consisting of base station transceiver (namely Node B) and RNC, and this communication mode is also called UP-UTRAN-DOWN mode. However, in some cases when two UEs camping in the same cell are very close to each other, it can be a more reasonable way for them to communicate directly, rather than through the relaying of base stations. This method is the so-called peer-to-peer communication, abbr. as P2P.

FIG. 2 illustrates a P2P communication mode. As shown in FIG. 2, the dashed line represents signaling link, the solid line for data link, and the arrowhead for direction of information flow. Only signaling link exists between the UTRAN and the UE (mobile terminal), while only data link exists between the two communicating UEs. Assume that only resource for maintaining basic communication is needed. A direct link is taken as a unit of radio resource (having fixed frequency, timeslot and spreading code), it can be easily drawn that P2P communication mode only needs two units of radio resource to maintain basic communication. If additional signaling cost for management is ignored, P2P communication can save about 50% radio resource than conventional communication mode. Furthermore, the UTRAN still holds control over P2P communication, especially over how to use radio resources, so wireless network operators can easily charge for the radio resources used by P2P communication.

Two methods and apparatuses for establishing P2P communication in wireless communication networks, as described in two patent application documents entitled “A Method and Apparatus for Establishing P2P Communication in Wireless Communication Networks” and “A Method and Apparatus for Establishing wireless P2P Communication”, filed by KONINKLIJKE PHILIPS ELECTRONICS N.V. on Mar. 7, 2003, Attorney's Docket No. CN030003 and CN030001, and application Ser. No. as 03119892.9 and 03119897.X respectively, are suitable to any TDD CDMA communication system including TD-SCDMA systems, and incorporated herein as reference.

A method and apparatus for radio link establishment and maintenance with P2P communication in wireless communication networks, as described in the patent application document entitled “A Method and Apparatus for Radio Link Establishment and Maintenance with P2P Communication in Wireless Communication Networks”, filed by KONINKLIJKE PHILIPS ELECTRONICS N.V. on Mar. 7, 2003, Attorney's Docket No CN030005 and application Ser. No. as 03119895.3, is suitable to any wireless communication system including TD-SCDMA systems, and incorporated herein by reference.

After establishing uplink synchronization with the UTRAN through random access procedure the same as existing TD-SCDMA systems, the UE establishes P2P direct link with the other UE, in accordance with the methods and apparatuses as described in the application documents whose application serial number are 03119892.9 and 03119897.X, i.e.: allocate relevant dedicated resource to two P2P communicating UEs. Then, direct link between the two UEs can be established and maintained in accordance with the method and apparatus as described in the application document whose application serial number is 03119895.3, so that the two UEs can receive and transmit P2P signals in the allocated timeslots respectively, and thus P2P communication between two UEs can be implemented.

However, the mobility of P2P communicating UEs may cause variation in position of the UEs and the communication environment, thus lose the P2P communication. In this situation, how to switch seamlessly from P2P communication mode to conventional communication mode without obvious consciousness of users, is a problem to be considered when P2P communication mode is employed.

Moreover, when two UEs communicating in conventional UP-UTRAN-DOWN mode can satisfy P2P communication requirement, it's better to establish a P2P link between them to save radio resource and enhance system capacity. But it's also a great challenge to introduce P2P mode as how to switch from conventional communication to P2P communication seamlessly without obvious consciousness of communicating users.

### SUMMARY OF THE INVENTION

An object of the present invention is to provide a method and apparatus for switching from P2P communication to conventional communication in wireless communication systems, so as to switch to conventional mode smoothly without obvious consciousness of communicating users when P2P communication can't be conducted.

Another object of the present invention is to provide a method and apparatus for switching from conventional communication to P2P communication in wireless communication systems, so that it is switched to P2P mode smoothly without any notice of communicating users when the P2P communication requirement can be satisfied, and thus to save radio resource.

To achieve the above object, a method is proposed for switching from P2P communication mode to UP-UTRAN-DOWN communication mode, be executed by a UE in wireless communication systems in accordance with the present invention, comprising: (a) detecting the direct link used by the UE in P2P communication with the other UE; (b) sending a request for switching to conventional communication mode to a wireless communication network system, if the detection result indicates that the communication quality of the direct link can't satisfy the requirement for P2P communication; and (c) establishing conventional communication link to communicate with the other UE in conventional communication mode, after receiving the ACK message of the switch request sent by the network system.

To achieve the above object, a method is proposed for the UE to switch from P2P communication mode to UP-UTRAN-DOWN communication mode, performed by the network system in wireless communication systems in accordance with the present invention, comprising: (A) receiving a request for switching to conventional communication mode from a UE in P2P communication mode; (B) responding the switch request for switching to conventional communication mode and allocating traffic channel in conventional communication mode to the two UEs in P2P communication mode; (C) sending ACK messages of the switch request to the two UEs so that the two UEs can establish conventional communication link.

To achieve the above object, a method is proposed for switching from UP-UTRAN-DOWN communication mode (called as conventional communication mode) to P2P communication mode, performed by a UE in wireless communication systems in accordance with the present invention, comprising: (a) receiving control information from the wireless communication network system; (b) overhearing the information transferred on the uplink between the network system and the other UE in conventional communication with the UE, according to the control information; (c) detecting whether the UE can overhear the information transferred on the uplink, to determine whether the communication quality of the uplink can satisfy the requirement for P2P communication between the other UE and the UE; and (d) establishing P2P link with the other UE by employing the uplink, so that the UE can communicate with said another UE in P2P communication mode, if the detection result indicates that the uplink can satisfy the quality requirement for P2P communication.

To achieve the above object, a method is proposed for the UE to switch from UP-UTRAN-DOWN communication mode (called as conventional communication mode) to P2P communication mode, performed by the wireless communication network system in wireless communication systems in accordance with the present invention, comprising: (a) determining whether the two UEs satisfy the requirement for establishing P2P communication; (b) sending control information to the two UEs respectively to instruct them to overhear information transferred on the uplink between their peers and the network system, if the two UEs satisfy the requirement for establishing P2P communication; (c) receiving notification messages from the two UEs, indicating that each of the two UEs can overhear information transferred on the uplink between its peer and the network system; (d) sending instruction messages to the two UEs respectively to instruct them to establish mutual P2P communication.

### BRIEF DESCRIPTION OF THE ACCOMPANYING DRAWINGS

FIG. 1 is a schematic diagram illustrating conventional UP-UTRAN-DOWN communication mode;

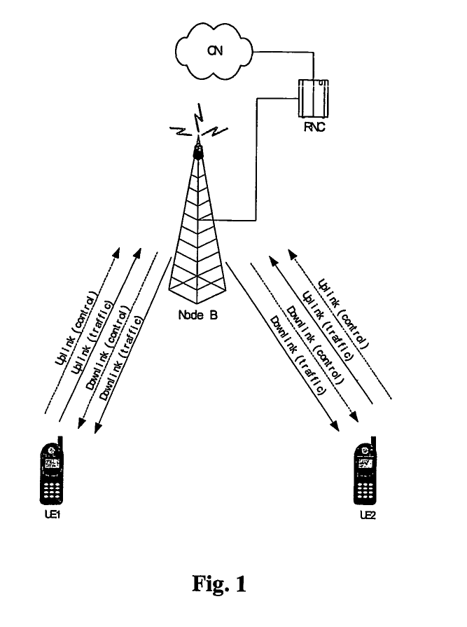

FIG. 2 is a schematic diagram illustrating the P2P communication mode in accordance with the present invention;

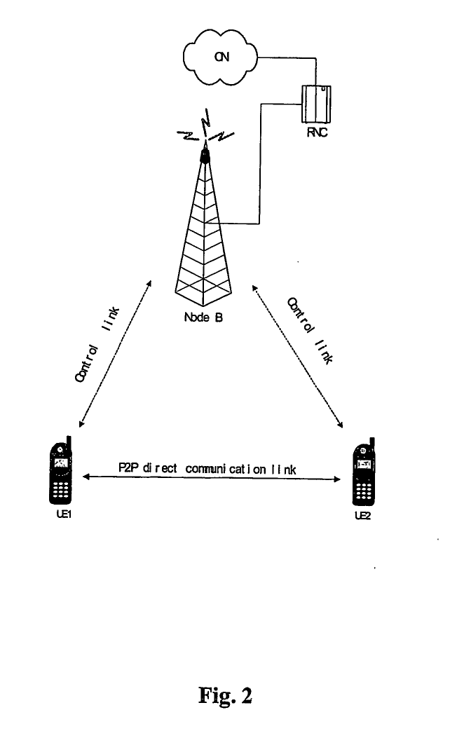

FIG. 3 is a schematic diagram illustrating the UE's state transitions for soft switching between P2P and conventional communication mode in accordance with the present invention;

FIG. 4 is a flow chart illustrating switching from P2P mode to conventional mode in accordance with the present invention;

FIG. 5 is a flow chart illustrating switching from conventional mode to P2P mode in accordance with the present invention;

### DETAILED DESCRIPTION OF THE INVENTION

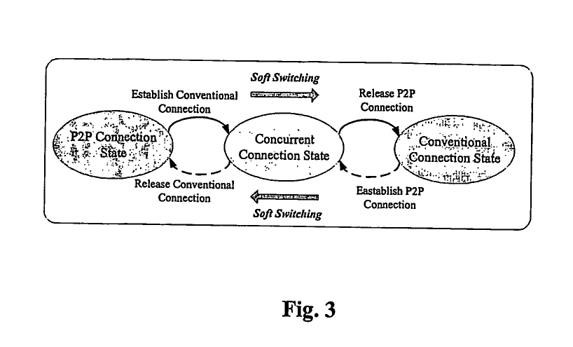

First, a description will be given below about state transitions of a UE capable of communicating in P2P mode, when switching between P2P mode and conventional mode, in conjunction with FIG. 3, by taking TD-SCDMA system as an example.

As FIG. 3 shown, when the P2P communication link of a P2P UE can't satisfy direct communication requirement due to change of the UE's position and its communication environment, it's necessary for the UE to switch from P2P communication mode to conventional communication mode. At this time, the UE will leave the mere P2P connection state and enter concurrent state of P2P communication and conventional communication. In concurrent state, the UE tests the conventional link established via the network system to be used in conventional communication mode when keeping the previous P2P link to maintain P2P communication, till the testing result shows that the conventional link can satisfy the conventional communication requirement for the UE. That is, the UE enters mere conventional connection state in conventional communication only after conventional link is already established successfully between the UE and the network system.

On the other hand, the procedure of switching from conventional communication mode to P2P communication mode for a UE is just opposite to the above procedure. Specifically, when two communicating UEs with conventional communication mode satisfy the requirement for P2P communication, that is, the distance between the UEs falls within the P2P-supported radio range, the two UEs both have P2P communication capability, and the two UEs must camp in the same cell, the network system should instruct the two UEs to switch from conventional communication mode to P2P communication mode, thus to save radio resource. At this time, each of the two UEs will leave the previous mere conventional communication connection state, and enter concurrent state of P2P communication and conventional communication. In concurrent state, each UE respectively overhears the information transferred on the uplink between its peer and the network system while keeping previous conventional communication link to maintain conventional communication, and tests the corresponding uplink according to the overheard information, till the testing result shows the uplink between each of the two UEs and the network system can satisfy the QoS requirement for P2P communication as the P2P communication link between the two UEs. That is, the two UEs respectively enter mere P2P communication connection state only after P2P link is already established between the two UEs successfully.

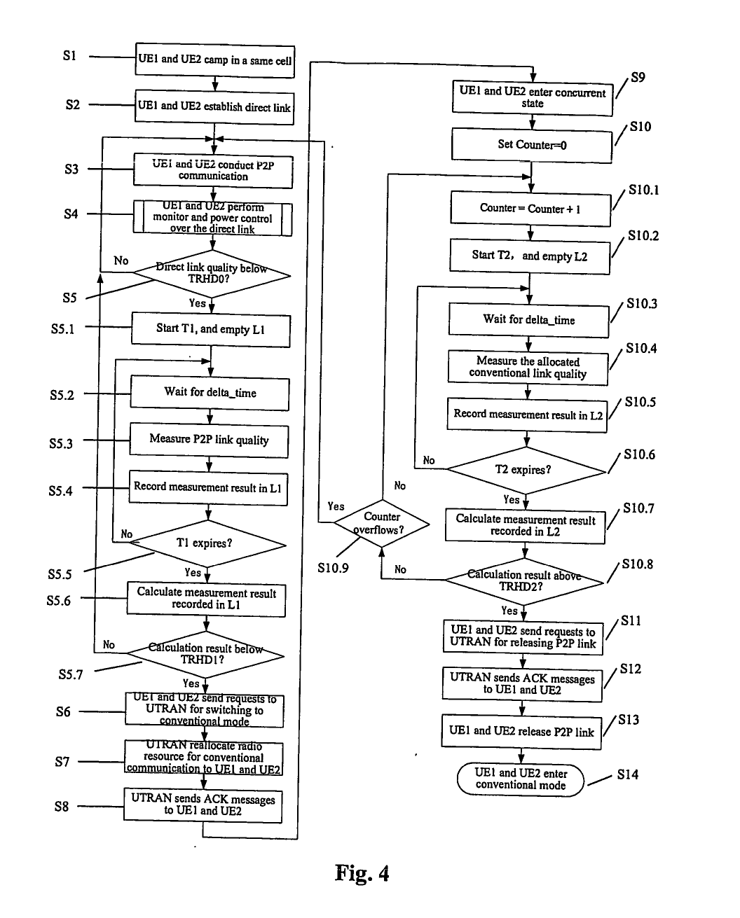

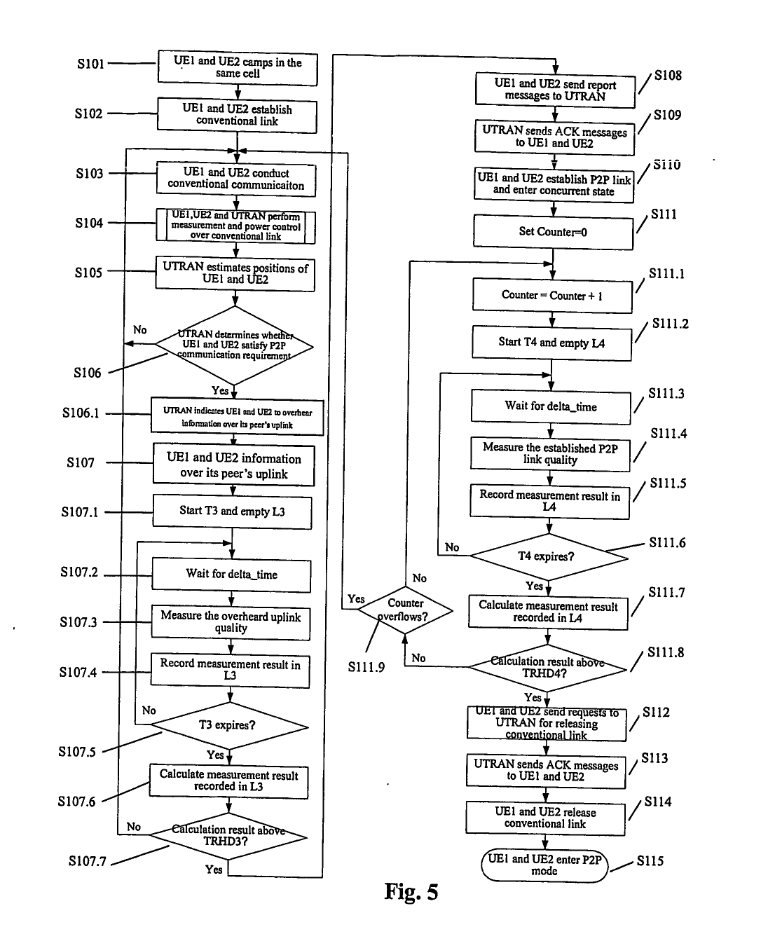

Detailed descriptions will respectively be given below to the above switching procedures from P2P communication mode to conventional communication mode and from conventional communication mode to P2P communication mode, in conjunction with FIG. 4 and FIG. 5.

As shown in FIG. 4, for UE1 and UE2 camping in the same cell (step S1), if the P2P communication requirement is satisfied, P2P link between the two UEs is established (step S2), and UE1 and UE2 conduct direct communication via the P2P link (step S3). This procedure is described in detail in the above patent application documents whose application IDs are 03119892.9 and 03119897.X.

During direct communication procedure, UE1 and UE2 who are in P2P mode, keep on monitoring the direct link to control its peer's P2P signal transmission power (step S4). This procedure is described in detail in the patent application document with application ID 03119895.3. During the monitoring procedure, when one UE detects that the P2P link quality is lower than a predefined value such as threshold TRHD0 (step S5), the UE needs to take steps as: start a timer T1 and empty previous testing result recorded in the quality record list L1 (step S5.1). After a time interval of delta_time (step S5.2), the UE tests the P2P link quality at this time (step S5.3), and records the testing result in the quality record list L1 (step S5.4). Check whether timer T1 expires with the predefined time (step S5.5). If not, iterate the above steps S5.2 to S5.4; if T1 expires, calculate the testing result recorded in the quality record list L1 within the predefined time of timer T1 (referred as T1′ later), to get the P2P link communication quality in T1′ (step S5.6). Judge whether the P2P link communication quality in T1 is lower than a predefined value such as threshold TRHD1 (step S5.7). If it's not lower than TRHD1, return to step S3 and the UE continues direct communication; if it's lower than TRHD1, the UE sends a request for switching to conventional communication mode to the UTRAN (step S6).

Wherein the UE can send the request for switching to conventional communication mode to the UTRAN through uplink control channel (this channel is kept between the UE and the UTRAN during P2P communication process), or via the customized uplink channel between the UE and the UTRAN, which is described in the copending patent application entitled “A Method and Apparatus for Uplink Synchronization Maintenance with P2P Communication in Wireless Communication Networks”, filed by KONINKLIJKE PHILIPS ELECTRONICS N.V., Attorney's Docket No. CN030013 and application Ser. No. ______. In this application, uplink channel and downlink channel are customized between the UE and the UTRAN, and the UE can send control information to the UTRAN by employing the customized uplink channel. The method and apparatus is applicable to any wireless communication system including TD-SCDMA systems, and incorporated herein as reference.

Moreover, in the UTRAN, the request for switching to conventional communication mode from the P2P UE, has higher priority than the request for establishing conventional communication from other UEs.

Assume that the UTRAN can satisfy UEs' requests for radio resource at any moment. After receiving the request for switching to conventional communication mode from the P2P UE, the UTRAN reallocates the corresponding traffic channels in conventional communication mode for the two involved P2P UEs UE1 and UE2 (step S7), wherein the UTRAN only allocates corresponding traffic channel lacked for each UE. Specifically, if the traffic channel of P2P link between UE1 and UE2 occupies uplink timeslots, the UTRAN only needs to allocate corresponding downlink traffic channel for UE1 and UE2 and the uplink traffic channel can still adopt P2P dedicated channel P2P-DCH; if the traffic channel of P2P link between UE1 and UE2 occupies downlink timeslots, the UTRAN only needs to allocate corresponding uplink traffic channel for UE1 and UE2 and the downlink traffic channel can still adopt P2P dedicated channel P2P-DCH; if the traffic channel of P2P link between UE1 and UE2 occupies an uplink timeslot and a downlink timeslot, the UTRAN only needs to allocate a corresponding uplink traffic channel and a corresponding downlink traffic channel for UE1 and UE2, the allocated uplink traffic channel and downlink traffic channel along with the P2P dedicated channel construct the communication links between UE1 and the UTRAN and between UE2 and the UTRAN in conventional communication mode.

Then, the UTRAN sends ACK messages of switch request to the two UEs respectively, to inform them about the reallocated traffic channels in conventional communication mode (step S8).

After receiving the ACK messages of switch request transmitted from the UTRAN via downlink control channel, UE1 and UE2 establish conventional link through the UTRAN and meanwhile UE1 and UE2 enter concurrent state of direct communication and conventional communication (step S9). In concurrent state, the two UEs test the established conventional link while keeping their previous P2P link to maintain current proceeding communication. Wherein steps to be executed by each UE include:

First, initialize the value Vₜₑₛₜ_{_{—}}_{conv} of a timer to 0 (step S10), wherein the timer is for recording the number for estimating the communication quality of the allocated conventional link in a certain time. Then, the UE increases the value Vₜₑₛₜ_{_{—}}_{conv} con of the timer by 1, to start the procedure for estimating the communication quality of the allocated conventional link in a certain time (step S10.1). The procedure includes: start a timer T2 in the UE, and empty previous testing result recorded in its quality record list L2 (step S10.2). After an interval of delta_time (step S10.3), the UE tests the P2P link quality of the conventional link allocated at this time (step S10.4), and records the testing result in quality record list L2 (step S5.4). Check whether timer T2 expires with the predefined time (step S10.6). If not, iterate the above steps S10.3 to S10.5; if T2 expires, calculate the testing result recorded in the quality record list L2 within the predefined time of timer T2 (referred as T2′ later), to get the P2P link communication quality in T2′ (step S10.7). Judge whether the P2P link communication quality in T2′ is higher than a predefined value such as threshold TRHD2 (step S10.8).

If the P2P link communication quality in T2's duration is not higher than threshold TRHD2, it indicates that the conventional link allocated to the UE can't satisfy requirement for conventional communication, then check whether Vₜₑₛₜ_{_{—}}_{conv} exceeds a predefined value Nₜₑₛₜ_{_{—}}_{conv}(step S10.9). If exceeding the predefined value Nₜₑₛₜ_{_{—}}_{conv} indicates that the communication quality of the UE's allocated conventional link has been estimated Nₜₑₛₜ_{_{—}}_{conv} times in T2′ and every time the estimation result shows the conventional link can't satisfy QoS requirement for conventional communication, then the UE can only return to the above step S3 and continue to use P2P mode to communicate. If Vₜₑₛₜ_{_{—}}_{conv} doesn't exceed the predefined value Nₜₑₛₜ_{_{—}}_{conv}, iterate the above steps S10.1 to S10.8, to start a new procedure for estimating the communication quality of the above conventional link within a certain time.

If the communication quality of the conventional link in T2′ is higher than threshold TRHD2, it indicates that the current allocated conventional link of the UE can satisfy the requirement for conventional communication. That is, after the conventional link has been established successfully between the UE and the network system, the UE sends a message to the UTRAN indicating that the allocated conventional link can satisfy the communication quality requirement, and meanwhile the UE requests for releasing the direct communication radio resource (step S11).

After respectively receiving the requests for releasing the direct communication radio resource sent by the two UEs, the network system UTRAN reclaims P2P communication radio resource and sends ACK messages of requests for releasing P2P communication radio resource to the two UEs respectively (step S12). After receiving the ACK messages of requests for releasing P2P communication radio resource transmitted by the network system via downlink channel, the two UEs release the P2P link (step S13), respectively enter mere connection state of conventional communication mode, and continue to mutually communicate with conventional UP-UTRAN-DOWN mode (step S14).

Wherein the UEs can't enter mere conventional UP-UTRAN-DOWN mode entirely before direct communication resource is release completely, during the above switching procedure from P2P communication mode to conventional communication mode. In other words, only after the two UEs can communicate through the network system UTRAN, the P2P link between the two UEs can be broken down, thus to guarantee ‘soft’ or “transparent” switching to conventional communication mode.

A detailed description is given above to the switching procedure from P2P communication mode to conventional communication mode in accordance with the present invention, in conjunction with FIG. 4. In the following, a description will go to the switching procedure from conventional communication mode to P2P communication mode in accordance with the present invention, in conjunction with FIG. 5.

As FIG. 5 shown, UE1 and UE2 camping in the same cell (step S101), respectively establish conventional UP-UTRAN-DOWN link through the network system UTRAN (step S102). By employing the established conventional traffic channel, UE1 and UE2 carry out mutual communication in conventional mode (step S103). Step S101 to S103 are the same as procedures described in existing 3GPP protocols.

During the communication procedure in conventional mode, the two communicating UEs and the UTRAN are keeping on monitoring the conventional link and perform power control procedure in conventional communication (step S104).

During conventional communication procedure, the UTRAN can regularly or irregularly estimate the acquired position information of the UEs (step S105), for instance, the UTRAN can acquire the position information of UE1 and UE2 through searching and locating positions of UE1 and UE2, or through the UEs' position information included in messages sent to the network system by UE1 and UE2.

Meanwhile, the UTRAN constantly detects whether the two communicating UEs UE1 and UE2 can satisfy the following three conditions at the same time (step S106):

(1) the distance between UE1 and UE2 falls within the P2P-supported radio range according to the above position information of the UEs acquired by the UTRAN;

(2) UE1 and UE2 both have P2P communication capability;

(3) UE1 and UE2 camp in the same cell.

If UE1 and UE2 can't satisfy the above three conditions at the same time, the UTRAN can't attempt to start the switching from conventional communication mode to P2P communication mode. If UE1 and UE2 can satisfy the above three conditions at the same time, the UTRAN will instruct UE1 and UE2 to respectively overhear the information transferred on the uplink between its peers and the UTRAN (step S106.1), i.e.: UE1 overhears the information transferred on the uplink between UE2 and the UTRAN while UE2 overhears the information transferred on the uplink between UE1 and the UTRAN (step S107).

While overhearing information transferred on the uplink between its peer and the UTRAN, each UE detects whether it can overhear information transferred on the uplink clearly, to determine whether the uplink can satisfy the requirement for P2P communication between UE1 and UE2. During the detection procedure, steps to be executed by each UE include:

First, start a timer T3 in the UE, and empty the previous testing result recorded in the quality record list L3 (step S107.1). After a time duration of delta_time (step S107.2), test the quality of the uplink overheard by the UE (step S107.3), and record the testing result in the quality record list L3 (step S107.4). Check whether timer T3 expires with the predefined time (step S107.5). If not, iterate the above steps S107.2 to S107.4; if T3 expires, calculate the testing result recorded in quality record list L3 in time defined by T3 (referred as T3′ later), to get the communication quality of the overheard uplink in T3′ (step S107.6). Judge whether the communication quality of the overheard uplink in T3's is higher than a predefined value, such as threshold TRHD3 (step S107.7). If not higher than threshold TRHD3, return to step S103 and the UE continues to use conventional mode to communicate; if higher than TRHD3, the UE sends a message to the UTRAN to notify the UTRAN that it can overhear information transferred on the uplink between its peer and the UTRAN clearly (step S108).

After receiving the above notification messages from UE1 and UE2, i.e.: when both UE1 and UE2 can overhear information transferred on the uplink between its peer and the UTRAN clearly, the UTRAN send control information to UE1 and UE2 respectively to instruct the two UEs to establish P2P communication (step S109).

After receiving the instruction for establishing P2P link from the UTRAN, UE1 and UE2 establish P2P link between them, and enter concurrent state of conventional communication and P2P communication from previous mere conventional communication mode (step S110). In concurrent state, UE1 and UE2 test the established P2P link while keeping previous conventional link to maintain proceeding communication. Wherein steps to be executed by each UE include:

First, initialize the value Vₜₑₛₜ_{_{—}}ₚ₂ₚ of a timer to 0 (step S111), wherein the timer is for recording the number for estimating the communication quality of the established P2P link in a certain time. Then, the UE increases the value Vₜₑₛₜ_{_{—}}ₚ₂ₚ of the timer by 1, to start the procedure of estimating the communication quality of the established P2P link in a certain time once (step S111.1). This procedure includes: start a timer T4 in the UE, and empty previous testing result recorded in its quality record list L4 (step S111.2). After a time of delta_time (step S111.3), the UE tests the quality of the established P2P link (step S111.4), and records the testing result in the quality record list L4 (step S111.5). Check whether timer T4 expires with the predefined time (step S111.6). If not, iterate the above steps S111.3 to S111.5; if T4 expires, calculate the testing result recorded in quality record list L4 in time defined by T4 (referred as T4′ later), to get the communication quality of the P2P link in T4′ (step S111.7). Judge whether the communication quality of the P2P link in T4′ is higher than a predefined value, such as threshold TRHD4 (step S111.8).

If the communication quality of the P2P link in T4′ is not higher than threshold TRHD4, it indicates that the current established P2P link between UE1 and UE2 can't satisfy the requirement for P2P communication, then check whether the value Vₜₑₛₜ_{_{—}}ₚ₂ₚ of the timer is larger than a predefined value Nₜₑₛₜ_{_{—}}ₚ₂ₚ (step S111.9). If larger than Nₜₑₛₜ_{_{—}}ₚ₂ₚ, it indicates that the communication quality of the established P2P link in T4′ has been estimated Nₜₑₛₜ_{_{—}}ₚ₂ₚ times and every time the estimation result shows the P2P link can't satisfy the QoS requirement for P2P communication, then the UE can only return to the above step S103 and continue to use conventional mode to communicate. If not exceeds Nₜₑₛₜ_{_{—}}ₚ₂ₚ, iterate the above steps S111.1 to S111.8, to start a new procedure for estimating the communication quality of the established P2P link in a certain time.

If the communication quality of the P2P link in T4's defined duration is higher than threshold TRHD4, it indicates that the current established P2P link between UE1 and UE2 can satisfy the requirement for P2P communication. That is, after the P2P link is established successfully between UE1 and UE2, the UE sends a message to the UTRAN, indicating that the established P2P link can satisfy the QoS requirement, and the UEs request for releasing conventional communication radio resource at the same time (step S112).

After receiving the requests for releasing conventional communication radio resource from UE1 and UE2 respectively, the UTRAN reclaims the downlinks radio resources between the UTRAN and UE1 and UE2, and sends ACK message of releasing conventional communication radio resource to the two UEs respectively (step S113). After receiving the ACK message of releasing conventional communication radio resource from the UTRAN, UE1 and UE2 release their conventional link (step S114), respectively enter single P2P communication mode connection state, and continue to communicate via the mutual direct link (step S115).

Wherein the UEs can't enter mere P2P mode entirely before conventional communication resource is released completely, during the switching procedure from conventional communication mode to P2P communication mode. In other words, only after the two UEs can communicate through the mutual direct link, the conventional link between the two UEs and the UTRAN can be broken down, thus to guarantee ‘soft’ or “transparent” switching to P2P communication mode.

The above method for switching from P2P communication mode to conventional communication mode or from conventional communication mode to P2P communication mode in accordance with the present invention, can be implemented in computer software, or in hardware, or in combination of software and hardware.

### BENEFICIAL RESULTS OF THE INVENTION

As described above, in the method and apparatus for switching from P2P communication mode to conventional communication mode in TD-SCDMA systems provided in the present invention, the UEs stay in concurrent state of P2P communication and conventional communication before switching from previous single P2P communication mode to mere conventional communication mode, so the UEs can enter mere conventional UP-UTRAN-DOWN mode entirely only after the direct communication resource is released completely. In another word, two UEs can still continue to use P2P mode to communicate in concurrent state and the P2P link between the two UEs can be broken down only after they can communicate through the network system UTRAN, thus achieve “soft” or “transparent” switching to conventional communication mode without being noticed by the involved UEs.

Similarly, in the method and apparatus for switching from conventional communication mode to P2P communication mode in TD-SCDMA systems provided in the present invention, the UEs also stay in concurrent state of P2P communication and conventional communication before switching from previous mere conventional communication mode to mere P2P communication mode, so the UEs can enter mere conventional P2P mode entirely only after the conventional communication resource is released completely. In another word, two UEs can still continue to use conventional mode to communicate in concurrent state and the conventional link between the two UEs and the UTRAN can be broken down only after they can communicate through the mutual direct link, thus achieve “soft” or “transparent” switching to P2P communication mode without being noticed by the involved UEs.

Furthermore, during the procedure switching from P2P mode to conventional communication mode, the previous P2P link can be taken as uplink or downlink when the UE employs conventional communication mode, and the UTRAN may only allocate corresponding downlink traffic channel and/or uplink traffic channel to the UE requesting for switching to conventional communication mode. While during the procedure switching from conventional communication mode to P2P mode, half radio resource of the previous conventional link, such as the uplink between the UE and the UTRAN, can still be reused as P2P link in P2P communication, and the UTRAN only reclaims half of the conventional radio resource. The resource allocation and reclaiming described in the present invention can effectively simplify the radio resource allocation procedure when switching between P2P communication mode and conventional communication mode.

Although the method and apparatus for soft switching between P2P communication mode and conventional communication mode in TD-SCDMA systems provided in the invention has been shown and described with respect to exemplary embodiments of TD-SCDMA, it should be understood by those skilled in the art that the method and apparatus are not limited hereof, but also suitable to other TDD CDMA systems.

It is also to be understood by those skilled in the art that the method and apparatus for soft switching between P2P communication mode and conventional communication mode in TD-SCDMA systems disclosed in this invention can be modified considerably without departing from the spirit and scope of the invention as defined by the appended claims.

What is claimed is:

1. A method performed by a user equipment in wireless communication systems, for switching from P2P (Peer_to_Peer) communication mode to UP-UTRAN-DOWN communication mode (called as conventional mode), comprising steps of:
(a) detecting the direct link used by the user equipment in P2P communication with the other user equipment;
(b) sending a request for switching to conventional communication mode to a wireless communication network system, if the detecting result indicates that the communication quality of the direct link can't satisfy the requirement for P2P communication; and
(c) establishing conventional communication connection to communicate with said the other user equipment in conventional communication mode, after receiving acknowledge (ACK) message of the request for switching sent by the network system.

2. The method according to claim 1, wherein step (c) includes:
(c1) entering concurrent state of P2P communication and conventional communication, after receiving the ACK message of the request for switching sent by the network system and acquiring the allocated conventional communication mode traffic channel;
(c2) testing the acquired traffic channel in conventional communication mode after entering concurrent state;
(c3) sending a request for releasing P2P communication radio resource to the network system if the testing result indicates that the communication quality of the traffic channel in conventional communication mode can satisfy the requirement for conventional communication; and
(c4) releasing the radio resource occupied by the direct link so that the user equipment can switch from the concurrent state to single conventional communication mode after receiving the ACK message of the request for releasing P2P communication radio resource sent by the network system.

3. The method according to claim 2, wherein the user equipment can send said request for switching to conventional communication mode and said request for releasing P2P communication radio resource to the network system, via any channel of the uplink control channel and the customized uplink channel.

4. The method according to claim 1, 2 or 3, wherein step (b) includes:
(b1) testing the communication quality of said direct link at every other certain interval and acquiring the corresponding testing result, if the detecting result indicates that the communication quality of said direct link is under a predefined value;
(b2) computing the communication quality of said direct link in the interval according to the acquired testing result in the predetermined interval; and
(b3) sending said request for switching to conventional communication mode to the network system if the computed result indicates that the communication quality of said direct link can't satisfy the requirement for P2P communication.

5. The method according to claim 4, further comprising:
(b4) continuing with P2P communication mode if the computed result indicates that the communication quality of said direct link can satisfy the requirement for P2P communication.

6. The method according to claim 2, wherein step (c2) includes:
(c21) testing the communication quality of the traffic channel in said conventional communication mode at every other certain interval and acquiring the corresponding testing result, after entering concurrent state; and
(c22) computing to get the communication quality of said traffic channel in conventional communication mode in the interval, according to the testing result acquired in the predetermined interval.

7. The method according to claim 6, further comprising:
counting the number of computing the communication quality of said traffic channel in conventional communication mode in said interval; and
testing and computing the communication quality of said conventional communication mode traffic channel in said interval again after increasing the number, if the number doesn't exceed a predefined value.

8. The method according to claim 7, further comprising:
continuing with P2P communication mode if said number exceeds a predefined value.

9. The method according to any one of claims 1 to 3, wherein the traffic channel of direct communication link can be taken as one of uplink traffic channel and downlink traffic channel in conventional communication mode.

10. A method performed by the wireless communication network system in wireless communication systems, for switching user equipments from P2P (Peer to Peer) communication mode to UP-UTRAN-DOWN communication mode (called as conventional communication mode), comprising:
(A) receiving requests from UE in P2P communication mode for switching to conventional communication mode;
(B) responding to the requests for switching to conventional communication mode and allocating traffic channel in conventional communication mode to the two user equipments in P2P communication mode; and
(C) sending ACK messages of the requests for switching to the two user equipments, so that the two user equipments can establish conventional communication connection.

11. The method according to claim 10, wherein further comprising:
(D) receiving requests for releasing P2P communication radio resource from the two user equipments; and
(E) responding to the requests for releasing P2P communication radio resource and reclaiming the P2P communication radio resource; and
(F) sending ACK messages of the requests for releasing P2P communication radio resource to the two user equipments, so that the two user equipments can switch from said concurrent state to single conventional communication mode, after reclaiming the P2P communication radio resource.

12. The method according to claim 10 or 11, wherein the conventional communication mode traffic channel allocated by said network system to the two user equipments, at least contains one of the downlink traffic channel and the uplink traffic channel.

13. A method performed by a user equipment for switching from UP_UTRAN_DOWN (called as conventional communication mode) to P2P communication mode, comprising:
(a) receiving control information from the wireless communication network system;
(b) overhearing the information transferred on the uplink between the network system and said the other user equipment communicating with the user equipment in conventional communication, according to the control information;
(c) detecting whether the user equipment can overhear the information transferred on the uplink, to determine whether the communication quality of the uplink can satisfy the requirement for P2P communication between the other user equipment and the user equipment;
(d) establishing P2P connection with the other user equipment by using the uplink, so that the user equipment can communicate with the other user equipment in P2P communication mode, if the detecting result indicates that the uplink can satisfy the quality requirement for P2P communication.

14. The method according to claim 13, wherein step (d) includes:
(d1) sending a notification message to the network system if the detecting result indicates that the uplink can satisfy the quality requirement for P2P communication; and
(d2) establishing P2P connection with said the other user equipment, according to the instruction message from the network system for establishing P2P connection.

15. The method according to claim 14, wherein step (d2) includes:
(d21) establishing P2P connection with the other user equipment and entering concurrent state of P2P communication and conventional communication, according to the instruction message for establishing P2P connection from the network system;
(d22) testing the established P2P link after entering concurrent state;
(d23) sending a request for releasing conventional communication radio resource to the network system, if the testing result shows that the communication quality of the P2P link can satisfy the requirement for P2P communication; and
(d24) releasing the radio resource occupied by the conventional link so that the user equipment can switch from the concurrent state of P2P communication and conventional communication to single P2P communication mode, after receiving the ACK message of the request for releasing conventional communication radio resource sent by the network system.

16. The method according to claim 13, 14 or 15, wherein step (c) includes:
(c1) testing the quality of the overheard uplink at every other certain interval and acquiring the corresponding testing result; and
(c2) computing the communication quality of the overheard uplink in the interval, according to the testing result acquired in the predetermined interval.

17. The method according to claim 13, further comprising:
(e) continuing with conventional communication mode if the testing result indicates that the uplink can't satisfy the quality requirement for P2P communication.

18. The method according to claim 15, wherein step (d22) includes:
(d221) testing the communication quality of said P2P link at every other certain interval and acquiring the corresponding testing result after entering concurrent state; and
(d222) computing to get the communication quality of said P2P link in the interval according to the testing result acquired in the predetermined interval.

19. The method according to claim 18, further comprising:
counting the number of computing the communication quality of said P2P link in said interval; and
testing and computing the communication quality of said P2P link in said interval again after increasing the number, if the number doesn't exceed a predefined value;

20. The method according to claim 19, further comprising:
continuing with conventional communication mode if said number exceeds a predefined value.

21. A method performed by the wireless communication network system in wireless communication systems for the user equipment to switch from UP_UTRAN_DOWN (conventional communication mode) to P2P communication mode, comprising:
(a) determining whether the two user equipments satisfy the condition of establishing P2P communication;
(b) sending control information to the two user equipments respectively to instruct them to overhear information transferred on the uplink between their peers and the network system, if the two user equipments satisfy the condition of establishing P2P communication;
(c) receiving notification messages from the two user equipments, which indicate that each of the two user equipments can overhear information transferred on the uplink between its peer and the network system; and
(d) sending instruction messages to the two user equipments respectively to instruct them to establish mutual P2P communication.

22. The method according to claim 21, further comprising:
(e) receiving requests for releasing conventional communication radio resource from the two user equipments; and
(f) sending ACK messages of the requests for releasing conventional communication radio resource to the two user equipments respectively, so that the two user equipments respectively switch from the concurrent state of P2P communication and conventional communication to single P2P communication mode.

23. The method according to claim 21 or 22, wherein step (a) includes:
(a1) determining whether the distance between the two user equipments falls within the scope of P2P communication, according to the position information of said two user equipments;
(a2) determining whether the two user equipments both have P2P communication capability;
(a3) determining whether the two user equipments camp in the same cell; and
(a4) determining that P2P communication can be established between the two user equipments when the two user equipments satisfy the conditions of step (a1), (a2) and (a3) concurrently.

24. The method according to claim 23, wherein the position information of said user equipments can be acquired according to one of the information acquired by searching and positioning the user equipments and the information sent by the user equipments to the network system.

25. A user equipment capable of switching from P2P communication mode to Up_UTRAN-DOWN (conventional communication mode) in wireless communication systems, comprising:
a direct link detecting means, for detecting the direct link for P2P communication between the user equipment and the other user equipment;
a switching request sending means, for sending a request for switching to conventional communication mode to a wireless communication network system when the detecting result indicates that the communication quality of the direct link can't satisfy the requirement for P2P communication; and
a conventional communication connection establishing means, for establishing connection of conventional communication to communicate with the other user equipment in conventional communication mode after receiving the ACK message of the request for switching sent by the network system.

26. The user equipment according to claim 25, wherein said conventional communication connection establishing means includes:
a concurrent state accessing means, for entering concurrent state of P2P communication and conventional communication after receiving the ACK message of the request for switching sent by the network system and acquiring the allocated traffic channel in conventional communication mode;
a conventional link testing means, for testing the acquired traffic channel in conventional communication mode after entering concurrent state; and
a radio resource releasing means, for releasing the radio resource occupied by the direct link so that the user equipment can switch from the concurrent state to single conventional communication mode after receiving the ACK message of the request for releasing the radio resource sent by the network system;
wherein said sending means sends a request for releasing P2P communication radio resource to the network system when the testing result of the conventional link testing means shows that the traffic channel in conventional communication mode can satisfy the quality requirement for conventional communication.

27. The user equipment according to claim 25 or 26, wherein said switching request sending means includes:
a testing means, for testing the communication quality of said direct link at every other certain interval and acquiring the corresponding testing result when the detecting result indicates that the communication quality of said direct link is below a predefined value;
a computing means, for computing the communication quality of said direct link in the interval according to the acquired testing result in the predetermined interval; and
a sending means, for sending said request for switching to conventional communication mode to the network system when said computed result shows that the communication quality of said direct link can't meet the requirement for P2P communication.

28. The user equipment according to claim 26, wherein said conventional link testing means includes:
a traffic channel testing means, for testing the communication quality of said traffic channel in conventional communication mode at every other certain intervals and acquiring the corresponding testing result after entering concurrent state; and
a traffic channel communication quality computing means, for computing to get the communication quality of said traffic channel in conventional communication mode according to the testing result acquired in the predetermined interval.

29. A wireless communication network system, capable of performing a method for the user equipment to switch from P2P communication mode to UP-UTRAN-DOWN (conventional communication mode), comprising:
a receiving means, for receiving the request from the UE in P2P communication mode for switching to conventional communication mode;
an allocating means, for responding to the request for switching to conventional communication mode and allocating traffic channel in conventional communication mode to the two user equipments in P2P communication mode; and
a sending means, for sending ACK messages of the requests for switching to the two user equipments so that convention communication connection between the two user equipments can be established and sending ACK messages of She requests for releasing P2P communication radio resource so that the two user equipments can switch from concurrent state of P2P communication and conventional communication to single conventional communication mode.

30. The network system according to claim 29, further comprising:
a P2P communication radio resource reclaiming means, for reclaiming P2P communication radio resource when said receiving means receives requests for releasing P2P communication radio resource from the two user equipments.

31. A user equipment in wireless communication systems, capable of switching from UP_UTRAN-DOWN (conventional communication mode) to P2P communication mode, comprising:
a receiving means, for receiving control information from the wireless communication network system;
an overhearing means, for overhearing information transferred on the uplink between the network system and the other user equipment communicating in conventional communication with the user equipment, according to the control information;
a detecting means, for detecting whether information transferred on the uplink can be overheard, so as to determine whether the communication quality of the uplink can satisfy the requirement for P2P communication between the user equipment and the other user equipment; and
a P2P connection establishing means, for establishing P2P connection with the other user equipment by using the uplink, so that the user equipment can communicate with said the other user equipment in P2P mode when the detecting result shows that the uplink satisfies the quality requirement for P2P communication.

32. The user equipment according to claim 31, wherein said P2P connection establishing means includes:
a sending means, for sending a notification message to the network system when detecting result shows that the uplink satisfies the quality requirement for P2P communication; and
an establishing means, for establishing P2P connection with said the other user equipment according to instruction messages for establishing P2P connection from the network system.

33. The user equipment according to claim 32, wherein said establishing means includes:
a concurrent state entering means, for establishing P2P connection with the other user equipment and entering concurrent state of P2P communication and conventional communication from conventional communication mode, according to instruction messages for establishing P2P connection from the network system;
a P2P link testing means, for testing the established P2P link after entering concurrent state, wherein said sending means sends a request for releasing conventional communication radio resource to the network system when the testing result of the P2P link testing means shows that the communication quality of the P2P link can satisfy the requirement for P2P communication; and
a radio resource releasing means, for releasing the radio resource occupied by the conventional link so that the user equipment can switch from the concurrent state of P2P communication and conventional communication to single P2P communication mode, after said receiving means receives the ACK message of the request for releasing conventional communication radio resource sent by the network system.

34. The user equipment according to claim 31, 32 or 33, wherein said detecting means includes:
an uplink testing means, for testing the quality of the overheard uplink once every certain interval and acquiring the corresponding testing result; and
a computing means, for computing the communication quality of the overheard uplink in the interval according to the acquired testing result in the predetermined interval.

35. The user equipment according to claim 33, wherein said P2P link testing means includes:
a P2P link testing result acquiring means, for testing the communication quality of said P2P link once every certain interval and acquiring the corresponding result after entering concurrent state; and
a P2P link computing means, for computing to get the communication quality of said P2P link in the interval according to the acquired testing result in the predetermined interval.

36. A wireless communication network system in wireless communication systems, capable of performing a method for the user equipment to switch from UP_UTRAN_DOWN (conventional communication) to P2P communication mode, comprising:
a determining means, for determining whether the two user equipments satisfy the requirement for establishing P2P communication;
an instructing means, for sending control information to the two user equipments respectively to instruct them to overhear information transferred on the uplink between their peers and the network system, when it's determined that the two user equipments satisfy the requirement for establishing P2P communication;
a receiving means, for receiving notification messages and requests for releasing conventional communication radio resource from the two user equipments, wherein the notification messages show that each of the two user equipments can overhear information transferred on the uplink between its peer and the network system; and
a sending means, for sending instruction messages to the two user equipments to instruct them to establish mutual P2P communication and sending ACK messages of the requests for releasing conventional communication radio resource to the two user equipments, so that the two user equipments can respectively switch from the concurrent state of P2P communication and conventional communication to single P2P communication mode.
